(19) United States
(12) Patent Application Publication
(10) Pub. No.: US 2024/0164879 A1
(43) Pub. Date: May 23, 2024

(54) INTERDENTAL CLEANER

(71) Applicant: Sunstar Suisse S.A., Etoy (CH)

(72) Inventor: Jürgen BUTZ, Utzenfeld (DE)

(21) Appl. No.: 18/552,485

(22) PCT Filed: May 20, 2022
(86) PCT No.: PCT/EP2022/063704

§ 371 Date: Sep. 26, 2023

(30) Foreign Application Priority Data
May 21, 2021 (DE) 10 2021 113 332.7

(51) Int. Cl. A61C 15/02; A46B 3/00; A46B 9/02; A46B 9/04; A46D 1/00

(52) U.S. Cl. CPC A61C 15/02; A46B 3/005; A46B 9/025; A46B 9/026; A46B 9/045; A46D 1/02; A46B 2200/108

(57) ABSTRACT

An interdental cleaner having a rod-shaped support made of a first plastic, which has a handle part at its rear end region and has a cover made of a soft flexible second plastic at its opposite front end region. Several radially-protruding fingers are situated on the outer side of the cover and are integrally joined to the cover in their base region. At least some of the fingers and preferably almost all the fingers have a slenderness of at least 3.0, wherein the slenderness results from the quotients of the axial length l of the finger and the maximum diameter d thereof in the base region (S=l/d). The slenderness (front slenderness) of at least some fingers is lower in a front region VB than the slenderness (rear slenderness) of at least some fingers in a rear region HB of the cover.

The invention relates to an interdental cleaner with a rod-shaped support made of a first plastic, which has a handle part at its rear end region and has a cover made of a soft flexible second plastic at its opposite front end region, wherein several radially-protruding fingers are situated on the outside of the cover and are integrally joined to the cover in their base region.

To clean the interdental spaces, interdental cleaners made of plastic are used, which have a rod-shaped support made of a first plastic, which has a typically plate-like, integrally-formed handle part at its rear end. A sleeve-like cover made of a soft flexible second plastic, e.g., a thermoplastic elastomer or silicone, is sprayed on the front end of the support. In order to improve the cleaning effect, the cover has, on its outside, radially-protruding fingers, or at least fingers protruding with a radial component, which fingers consist of the same material as the cover and are formed integrally therewith and joined thereto. On the one hand, the stability of the fingers must be sufficient that they do not tear off or buckle when the interdental cleaner is used. On the other hand, the fingers must deform easily in order to be able to penetrate very narrow gaps or interdental spaces and to clean them.

It is known that the cleaning effect of the interdental cleaner can be improved if the fingers are as slender as possible. DE 10 2018 008 963 A1 describes an interdental cleaner of the type mentioned which has relatively slender fingers, wherein the slenderness S results from the quotients of the axial length l of the finger and its maximum diameter in the base region (S=l/d). However, the cleaning effect of the interdental cleaner is a function of the geometric conditions in the interdental spaces to be cleaned, so that an interdental cleaner with fingers of a predetermined slenderness does not inevitably result in good cleaning results for all users.

The object of the invention is to provide an interdental cleaner of the type mentioned in which the fingers have an improved cleaning effect.

This object is achieved according to the invention by an interdental cleaner having the features of claim 1. According to the invention, the basic principle assumed is that the slenderness of the fingers of the interdental cleaner can differ from one another in different defined regions. First, a few definitions:

On its front end, facing away from the handle part, of the interdental cleaner, the cover comprises a tip region SB having a length in the range of 0.5 mm to 2.0 mm and preferably in the range of 1.0 mm to 1.5 mm. Preferably, the tip region SB has a length of 1.5 mm. Said tip region SB is not considered in the following consideration of the slenderness of the fingers, since some interdental cleaners have fingers of a different geometric design, and, in particular, stump fingers, in the tip region SB.

Furthermore, the cover has a functional region FB which abuts the tip region SB in the direction of the handle part and extends up to a rear finger closest to the handle part. The functional region FB is divided into a front region VB, which is directly adjacent to the tip region SB and has a length in the range of 1.0 mm to 2.5 mm, and in particular in the range of 1.5 mm to 2.0 mm, a rear region HB, which extends forwards from the rear finger and has a length in the range of 1.0 mm to 2.5 mm, and in particular in the range of 1.5 mm to 2.0 mm, and a central region MB, which is arranged between the front region VB and the rear region HB. In order to compare the slenderness of the fingers, preferably the front region VB and the rear region HB are considered and compared with one another. Preferably, the front region VB and/or the rear region HB have a length of 2.0 mm.

It is known that both the flexibility and the stability of the fingers are largely a function of their slenderness. The cover and the fingers are produced in a common injection-molding step in an injection-molding mold and have a shape which tapers radially outwards, i.e., tapers towards the tip of the fingers—in particular, in the form of a circular cone—in order to be able to easily demold the fingers after the injection-molding process. In order to avoid injury to the user's gums, the fingers are generally rounded at their radially outer end.

Typically, the fingers each have a circular cone shape, but cones having other cross-sectional shapes, e.g., an elliptical cone, a rectangular or square cone (pyramid), or a polygonal or n-sided polygonal cone, are also possible. In the following, a circular cone is used as an example, but the invention is not restricted thereto.

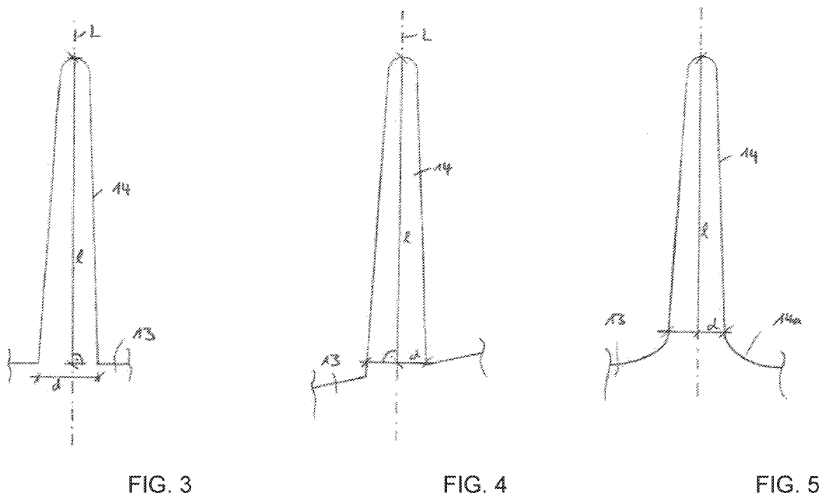

The slenderness S is defined as the quotient of the axial length l of the finger and its maximum diameter d in the base region (S=l/d). The cross-section of the finger that is decisive for determining the maximum diameter d is that cross-section which is only just completely within the finger, i.e., does not protrude into the cover. If the longitudinal central axis L of the finger extends perpendicularly to the surface of the cover, as is shown in FIG. 3, the cross-section of the finger that is decisive for determining the diameter d is the cross-section of the finger facing the surface of the cover. The axial length l of the finger then results from the distance of the decisive cross-section from the radially outer end of the finger.

If the longitudinal central axis L of the finger does not run perpendicularly to the surface of the cover, the cross-section that is decisive for the maximum diameter d is that cross-section which lies completely within the finger (see FIG. 4). The axial length l of the finger then results from the distance of the decisive cross-section from the tip of the finger.

If the finger transitions via a rounded portion into the cover, the decisive cross-section is not considered in the determination of the maximum diameter d of the lower cross-section, facing the cover, of the pure cone shape of the finger, i.e. the rounded transitional cross-section, as is shown in FIG. 5. Here too, the axial length l of the finger results from the distance of the decisive cross-section from the radially outer tip of the finger.

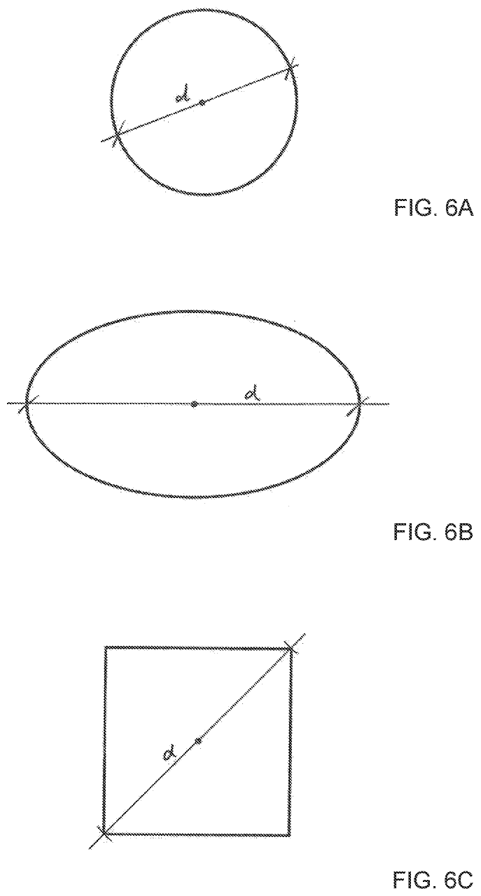

If the finger has the shape of a circular cone, the decisive cross-section of the finger in the base region also has a circular shape, and the diameter d results from the diameter of the circle at any point (see FIG. 6a).

If the finger has the shape of an elliptical cone, the decisive diameter d is the diameter on the longer principal axis of the ellipse (see FIG. 6b).

If the cross-section of the finger is a square, a rectangle, or a preferably uniform polygon, the decisive diameter d results from the maximum distance of two opposing vertices (see FIG. 6c).

The invention is based upon the basic principle of providing one or more fingers in the front region VB, which fingers have a lesser slenderness (front slenderness Sᵥ) than one or more fingers in the rear region HB (rear slenderness S_{H}).

In principle, it is provided that, in the front region VB, at least one of the fingers or at least 50% of all fingers there or at least 80% of all fingers there or even all fingers there have a front slenderness Sᵥ of at least 3.0.

For the rear region HB as well, it is provided that, in the rear region HB, at least one of the fingers or at least 50% of all fingers there or at least 80% of all fingers there or even all fingers there have a rear slenderness S_{H} of at least 3.0.

The difference in the slendernesses of the fingers between the front region VB and the rear region HB is that the front slenderness Sᵥ at least of one of the fingers arranged in the front region VB of the cover, or the front slenderness Sᵥ of at least 50% of all fingers there, or the front slenderness Sᵥ of at least 80% of all fingers there, or the front slenderness Sᵥ of all fingers there is less than the rear slenderness S_{H} of at least one of the fingers arranged in the rear region HB of the cover, or than the rear slenderness S_{H} of at least 50% of all fingers there, or than the rear slenderness S_{H} of at least 80% of all fingers there, or than the rear slenderness S_{H} of all fingers there.

The front slenderness Sᵥ is preferably 3% to 15% and in particular 5% to 10% less than the rear slenderness S_{H}.

In a preferred embodiment of the invention, it can be provided that the front slenderness Sᵥ be in the range of 3.0 to 5.0, and in particular in the range of 3.5 to 4.7.

Alternatively or additionally, it can be provided that the rear slenderness S_{H} be in the range of 3.5 to 5.5 and in particular in the range of 3.9 to 5.1.

In a further development of the invention, it can be provided that the maximum diameter in the base region of those fingers arranged in the front region VB of the cover be 5% to 15% less than the maximum diameter du in the base region of those fingers arranged in the rear region HB of the cover.

Additionally or alternatively, it can be provided that the axial length lᵥ of those fingers arranged in the front region VB of the cover be 5% to 15% less than the axial length l_{H} of those fingers arranged in the rear region HB of the cover.

In addition to the fingers having the stated slenderness, the interdental cleaner may also have fingers of a different shape and/or slenderness.

Further details and features of the invention will become apparent from the following description of an exemplary embodiment. The following are shown:

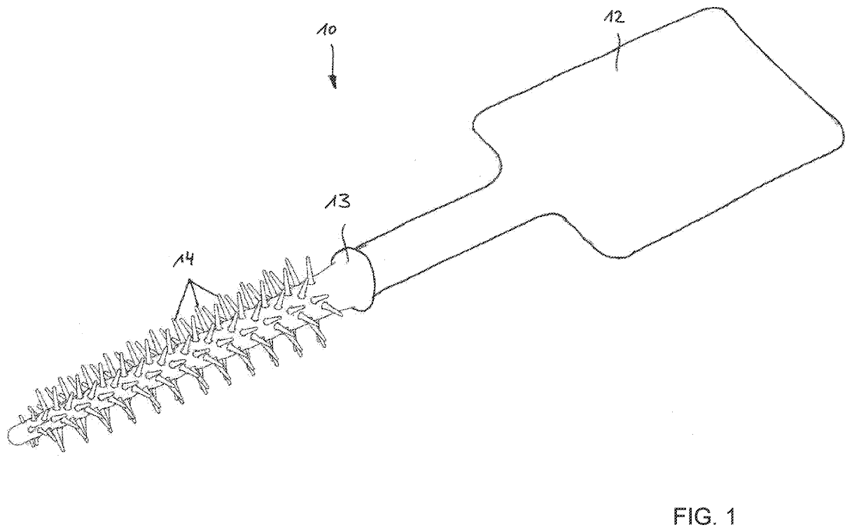

FIG. 1 a schematic perspectival view of an interdental cleaner,

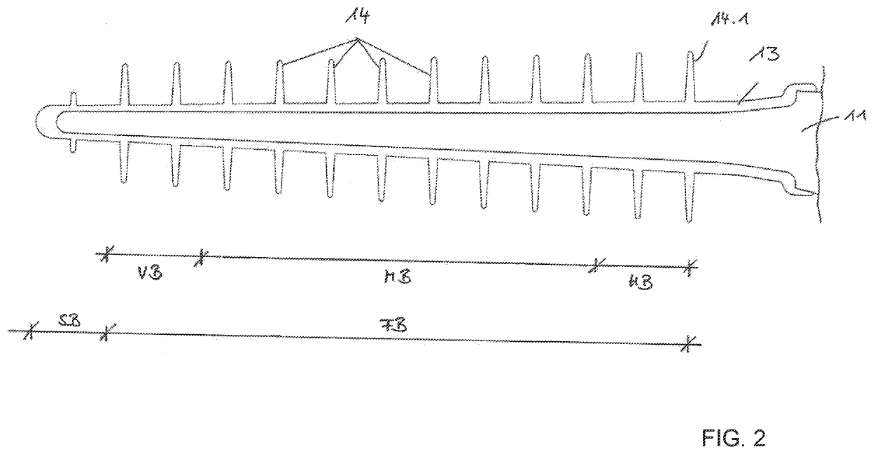

FIG. 2 a schematic longitudinal section through the front region of the interdental cleaner with the cover and the fingers,

FIG. 3 a first geometric configuration of a finger,

FIG. 4 a second geometric configuration of a finger,

FIG. 5 a third geometric configuration of a finger, and

FIGS. 6a, 6b, 6c possible cross-sectional shapes of a finger.

An interdental cleaner 10 shown in FIG. 1 has a rod-like support 11 made of a dimensionally-stable first plastic, which has at its rear end, shown on the right in FIG. 1, an integrally-formed, plate-like handle part 12 on which a user can grasp the interdental cleaner 10.

In its opposite front end region, the support 11 supports a sleeve-like cover 13 made of a soft flexible second plastic material—for example, a thermoplastic elastomer or silicone. Several radially outwardly-protruding fingers 14 are formed on the outer surface of the cover 13, which fingers are made of the same material as the cover 13 and are joined monolithically thereto. The fingers 14 have the shape of a cone—preferably a circular cone having a radially outwardly-tapering cross-section—and are rounded at their radially outer end.

FIG. 2 shows a schematic longitudinal section through the front region of the support 11, the cover 13, and the fingers 14. The cover 13 is divided into a front tip region SB, having a length in the range of 0.5 mm to 2.0 mm and preferably in the range of 1.0 mm to 1.5 mm, and a functional region FB, which adjoins the tip region SB in the direction of the handle part 12 and extends up to a rear finger 14.1 closest to the handle part 14. The functional region FB is divided into a front region VB, which is directly adjacent to the tip region SB and has a length in the range of 1.0 mm to 2.5 mm, and in particular in the range of 1.5 mm to 2.0 mm, a rear region HB, which extends forwards from the rear finger 14.1 and has a length in the range of 1.0 mm to 2.5 mm, and in particular in the range of 1.5 mm to 2.0 mm, and a central region MB, which is arranged between the front region VB and the rear region HB.

The slenderness S of a finger 14 is defined as the quotient of the axial length l of the finger 14 and its maximum diameter d in the base region (S=l/d). The cross-section of the finger 14 that is decisive for determining the maximum diameter d is that cross-section which is only just completely within the finger 14, i.e., does not protrude into the cover 13. If the longitudinal central axis L of the finger 14 extends perpendicularly to the surface of the cover 13, as is shown in FIG. 3, the cross-section that is decisive for determining the diameter d is the cross-section of the finger 14 facing the surface of the cover 13. The axial length l of the finger 14 then results from the distance between the decisive cross-section and the radially outer end of the finger 14.

If the longitudinal central axis L of the finger 14 does not run perpendicularly to the surface of the cover 13, the cross-section that is decisive for the maximum diameter d is that cross-section which lies completely within the finger 14 (see FIG. 4). The axial length l of the finger 14 then results from the distance of the decisive cross-section to the tip of the finger 14.

If the finger 14 transitions via a rounded portion 14a into the cover 13, the decisive cross-section is not considered in the determination of the maximum diameter d of the lower cross-section, facing the cover 13, of the pure cone shape of the finger 14, i.e., the rounded transitional cross-section, as is shown in FIG. 5. Here too, the axial length l of the finger 14 results from the distance of the decisive cross-section to the radially outer tip of the finger 14.

If the finger 14 has the shape of a circular cone, the decisive cross-section of the finger 14 in the base region has a circular shape, and the diameter d results from the diameter of the circle at any point, as is shown in FIG. 6a.

If the finger 14 has the shape of an elliptical cone, the decisive diameter d is the diameter on the longer principal axis of the ellipse, as shown in FIG. 6b.

If the cross-section of the finger 14 is a square, a rectangle, or a preferably uniform polygon, the decisive diameter d results from the maximum distance of two opposing vertices, as shown in FIG. 6c.

The invention is based upon the basic principle of providing one or more fingers 14 in the front region VB, which fingers have a lesser slenderness (front slenderness Sᵥ) than one or more fingers 14, 14.1 in the rear region HB (rear slenderness S_{H}).

In principle, it is provided that, in the front region VB, at least one of the fingers 14 or at least 50% of all fingers 14 there or at least 80% of all fingers 14 there or even all fingers 14 there have a front slenderness Sᵥ of at least 3.0.

For the rear region HB as well, it is provided that, in the rear region HB, at least one of the fingers 14 or at least 50% of all fingers 14 there or at least 80% of all fingers 14 there or even all fingers 14 there have a rear slenderness S_{H} of at least 3.0.

The difference in the slendernesses of the fingers 14 between the front region VB and the rear region HB is that the front slenderness Sᵥ at least of one of the fingers 14 arranged in the front region VB of the cover 13, or the front slenderness Sᵥ of at least 50% of all fingers 14 there, or the front slenderness Sᵥ of at least 80% of all fingers 14 there, or the front slenderness Sᵥ of all fingers 14 there is less than the rear slenderness S_{H} of at least one of the fingers 14 arranged in the rear region HB of the cover 13, or than the rear slenderness S_{H} of at least 50% of all fingers 14 there, or than the rear slenderness S_{H} of at least 80% of all fingers 14 there, or than the rear slenderness S_{H} of all fingers 14 there.

The front slenderness Sᵥ is preferably 3% to 15% and in particular 5% to 10% less than the rear slenderness S_{H}.

In a preferred embodiment of the invention, it can be provided that the front slenderness Sᵥ be in the range of 3.0 to 5.0, and in particular in the range of 3.5 to 4.7.

Alternatively or additionally, it can be provided that the rear slenderness S_{H} be in the range of 3.5 to 5.5 and in particular in the range of 3.9 to 5.1.

1. An interdental cleaner comprising:
a rod-like support made of a first plastic, which has a handle part at its a rear end region and a cover made of a soft flexible second plastic at an opposite front end region;
several radially-protruding fingers are situated on an outside of the cover and having a base region integrally joined to the cover;
the cover facing away from the handle part of the interdental cleaner has a tip region having a length in the range of 0.5 mm to 2.0 mm on a front end thereof, and a functional region, which adjoins the tip region in the direction of the handle part and extends up to a rear finger closest to the handle part;
the functional region being divided into a front region, which is directly adjacent to the tip region and has a length in the range of 1.0 mm to 2.5 mm, a rear region, which extends forward from the rear finger and has a length in the range of 1.0 mm to 2.5 mm, and a central region, which is arranged between the front region and the rear region;
in the front region, at least one of the fingers has a front slenderness of at least 3.0;
in the rear region, at least one of the fingers has a rear slenderness of at least 3.0;
wherein the slenderness results from quotients of an axial length l of the finger and a maximum diameter d in the base region such that the slenderness equals;
wherein the front slenderness of at least one of the fingers which are arranged in the front region of the cover is less than the rear slenderness of at least one of the fingers arranged in the rear region.

2. The interdental cleaner according to claim 1, wherein the front slenderness is 3% to 15% less than the rear slenderness.

3. The interdental cleaner according to claim 2, wherein the front slenderness is 5% to 10% less than the rear slenderness.

4. The interdental cleaner according to claim 1, wherein the front slenderness is in the range of 3.0 to 5.0.

5. The interdental cleaner according to claim 4, wherein the front slenderness is in the range of 3.5 to 4.7.

6. The interdental cleaner according to claim 1, wherein the rear slenderness is in the range of 3.5 to 5.5.

7. The interdental cleaner according to claim 6, wherein the rear slenderness is in the range of 3.9 to 5.1.

8. The interdental cleaner according to claim 1, wherein a maximum diameter in the base region of the fingers arranged in the front region of the cover is 5% to 15% less than a maximum diameter in the base region of the fingers arranged in the rear region of the cover.

9. The interdental cleaner according to claim 1, wherein the axial length of the fingers arranged in the front region of the cover is 5% to 15% less than the axial length of the fingers arranged in the rear region of the cover.

10. The interdental cleaner according to claim 1, wherein the tip region has a length in the range of 1.0 mm to 1.5 mm on the front end region thereof.

11. The interdental cleaner according to claim 1, wherein the front region, which is directly adjacent to the tip region, has a length in the range of 1.5 mm to 2.0 mm, and the rear region, which extends forward from the rear finger, has a length in the range of 1.5 mm to 2.0 mm.

12. The interdental cleaner according to claim 1, wherein at least 50% of all fingers in the front region have a slenderness of 3.0.

13. The interdental cleaner according to claim 1, wherein at least 80% of all fingers in the front region have a slenderness of 3.0.

14. The interdental cleaner according to claim 1, wherein all fingers in the front region have a slenderness of 3.0.

15. The interdental cleaner according to claim 1, wherein at least 50% of all fingers in the rear region have a slenderness of 3.0.

16. The interdental cleaner according to claim 1, wherein at least 80% of all fingers in the rear region have a slenderness of 3.0.

17. The interdental cleaner according to claim 1, wherein all fingers in the rear region have a slenderness of 3.0.
